(19) United States
(12) Patent Application Publication
(10) Pub. No.: US 2014/0345241 A1
(43) Pub. Date: Nov. 27, 2014

(54) BRUSH HARVESTERS OPERABLE BY HAND AND BY A VEHICLE

(71) Applicant: Paul Alan Alessi, Windellama (AU)

(72) Inventor: Paul Alan Alessi, Windellama (AU)

(21) Appl. No.: 14/241,391

(22) PCT Filed: Aug. 14, 2012
(86) PCT No.: PCT/AU2012/000956

§ 371 Date: Jun. 9, 2014

(30) Foreign Application Priority Data
Aug. 26, 2011 (AU) 2011903440
Sep. 2, 2011 (AU) 2011903573
Apr. 26, 2012 (AU) 2012100477

(51) Int. Cl. A01D 45/30

(52) U.S. Cl. CPC A01D 45/30
USPC 56/14.7; 56/130; 56/16.7

(57) ABSTRACT

There is disclosed a brush harvester including ground-engaging wheels so as to be operable in a walk-behind manner and/or by being pushed or pulled along the ground by a person walking on the ground. There is also disclosed a brush harvester unit mounted to a vehicle such as an ATV, so as to be operable by driving or riding the vehicle. There is additionally disclosed a brush harvester unit configurable for either of these modes of operation.

### FIELD OF THE INVENTION

The present invention relates to brush harvesters.

### BACKGROUND

Brush harvesting is a non-destructive technique for harvesting seeds from a stand of grass. With reference to FIG. 1, a conventional brush harvester BH comprises a rotary brush B, a cover or shroud S over the brush B, and a receptacle or hopper H behind the brush B. The brush B rotates such that a leading part thereof moves in an upward direction so as to remove mechanically, by a “brushing” action, seeds from a stand of grass G. The removed seeds are directed, by an airflow between the brush B and shroud S, to the hopper H, in which they are collected and from which they are subsequently removed. A vent V may be incorporated into the harvester H to allow escape of excess air.

The invention provides improvements in relation to brush harvesters.

### SUMMARY OF THE INVENTION

According to a first aspect of the present invention, there is provided a brush harvester including ground-engaging wheels so as to be operable by being pushed or pulled along the ground by a person walking on the ground. Preferably, the brush harvester is operable in a walk-behind manner.

According to a second aspect of the present invention, there is provided a brush harvester including ground-engaging wheels and being operable in a walk-behind manner.

In the preferred embodiments of the invention, the brush harvester is graspable to be operable in the walk-behind manner or by pushing or pulling thereof along the ground.

In the preferred embodiments of the invention, the harvester includes a powered rotary harvesting brush.

In the preferred embodiments of the invention, the brush harvester comprises a handle arrangement which is graspable to permit operation of the harvester in the walk-behind manner or by pushing or pulling thereof along the ground, which preferably comprises a crossbar extending generally parallel to an axis of rotation of the wheels but alternatively may, for example, comprise a pair of spaced apart graspable members, which, in the case of walk-behind operability, will be preferably be rearwardly projecting.

Preferably, the wheels are arranged at opposite sides of the harvester.

Preferably, the wheels are coaxial and the harvester includes a harvester unit, including a rotary brush, supported over the ground by the wheels, the unit being tiltable about the rotational axis of the wheels such that a spacing between the brush and the ground is adjustable.

Preferably, the harvester further includes at least one stand which is moveable between an extended condition, in which it engages the ground such that, in cooperation with the wheels, it supports the harvester in a substantially upright orientation on the ground, and a retracted condition, in which it allows operation of the harvester in the walk-behind manner or by pushing or pulling thereof along the ground. Preferably, the at least one stand comprises a pair of stands arranged at opposite lateral sides of the harvester. Preferably, the or each stand is a kickstand. Preferably, the or each stand is lockable in the extended condition. Preferably the or each stand is lockable in the extended condition by foot. Preferably, the or each stand is configured with a projection, such as a prong, which can penetrate soil or earth, whereby the or each stand may act as a park brake.

Preferably the wheels are, or resemble, bicycle wheels.

According to a third aspect of the present invention, there is provided a brush harvesting apparatus, comprising a vehicle and a brush harvester unit mounted to the vehicle.

Preferably, the brush harvester unit is detachably mounted to the vehicle.

Preferably, the unit is mounted at a front end of the vehicle. Alternatively, the unit may be mounted adjacent a rear end of the vehicle, and may be so mounted so as to be laterally offset from a centreline of the vehicle track/wheelbase.

In the preferred embodiments of the invention, the unit is mounted so as to be supported from the vehicle in cantilever fashion.

Preferably, the vehicle is a powered vehicle. In the preferred embodiments of the third aspect of the invention, the vehicle is motorised.

Preferably, the vehicle is an all-terrain vehicle (ATV). In one preferred embodiment of the invention, the ATV is a quad bike. In another preferred embodiment of the invention, the ATV comprises a seat which instead is not straddled by the operator; for example, the ATV may be one which is produced by Yamaha and referred to as the Rhino or one which is produced by John Deere and referred to as the Gator. Alternatively, the ATV may be a three-wheeler motorbike. Preferably, the unit is attached to a bull bar and/or bumper structure of the ATV, or to a carry rack and/or bumper structure of the ATV.

Generally speaking, an ATV travels on low pressure tires and comprises a seat for an operator and handlebars or a steering wheel for steering control. Such a vehicle is designed to handle a wider variety of terrain than most other vehicles. Advantageously, ATVs generally have a light footprint and travel relatively quickly.

According to a fourth aspect of the present invention, there is provided a brush harvester comprising a brush harvester unit, which includes a rotary brush, and coaxial ground-engaging wheels via which the unit is supported over the ground, wherein the unit is tiltable via the rotational axis of the wheels such that a spacing between the brush and the ground is adjustable.

According to a fifth aspect of the present invention, there is provided a brush harvester unit which is configured to be supported over the ground by ground-engaging wheels and to be operable, when so supported, in a walk-behind manner and/or by being pushed or pulled over the ground by a person walking on the ground, the unit being mountable at a front of a powered vehicle to be operable by driving of the vehicle.

Preferably, the unit is configured to be operable in the walk-behind manner and/or by being pushed or pulled over the ground by a person walking on the ground via a handle arrangement.

In one embodiment of the invention, the unit is configured to be coupled to the wheels to be operable in the walk-behind manner or by pushing or pulling thereof over the ground, and such that the wheels can be decoupled therefrom for mounting of the unit at the front of the vehicle to be operable by driving of the vehicle. In another embodiment of the invention, the unit is configured such that wheels are relocatable with respect thereto whereby the wheels are carried by the unit in a stowed condition when the unit is operable by driving of the vehicle.

In some embodiments, the handle arrangement may be integral with/a part of the unit.

In one embodiment of the invention, the unit is configured to be coupled to the handle arrangement to be operable in the walk-behind manner or by pushing or pulling thereof over the ground, and such that the handle arrangement can be decoupled therefrom for mounting of the unit at the front of the vehicle. In another embodiment of the invention, the unit is configured such that the handle arrangement is relocatable with respect thereto whereby the handle is carried by the unit in a stowed condition when the unit is operable by driving of the vehicle.

Preferably, the unit is configured to be mounted at the front of the powered vehicle via a rigid support member which extends upwardly therefrom and a tie, which may comprise, for example, a strap, rope, cable or chain, that attaches to an upper portion of the support member and extends rearwardly and downwardly from the upper portion to attach to the vehicle. Preferably, the unit is configured to be pivotally connected to the front of the powered vehicle via at least one connector, and the tie is adjustable in length to effect pivoting of the unit about the front/connector(s) and thus adjustment of the height of a rotary harvesting brush of the unit. Preferably, the or each connector is engageable with a bull bar structure and/or bumper of the vehicle, or carry rack and/or bumper of the vehicle. The or each connector may, for example, comprise a strap, chain, rope or cable. Alternatively, the or each connector may comprise a bracket.

In one embodiment of the invention, the unit is configured to be coupled to the support member to be mounted at the front of the vehicle, and such that the support member can be decoupled therefrom for operation of the unit in the walk-behind manner or by pushing or pulling thereof over the ground. In another embodiment of the invention, the unit is configured such that the support member is relocatable with respect thereto whereby the support member is carried by the unit in a stowed condition when the unit is operated in the walk-behind manner or by pushing or pulling thereof over the ground. In another embodiment, the unit is configured such that the support member remains fixed with respect to the unit and does not hinder the mounting of the unit to the vehicle; in such an embodiment, the support member may be integral with the unit.

In a preferred embodiment of the invention, the unit is configured to be mounted at the front of the powered vehicle via at least one connector engageable with the vehicle to secure the unit to the vehicle. Preferably, the or each connector is engageable with a bull bar structure and/or bumper of the vehicle, or carry rack and/or bumper of the vehicle. The or each connector may, for example, comprise a strap, chain, rope or cable. Alternatively, the or each connector may comprise a bracket.

In a preferred embodiment of the invention, the unit is configured to be mounted to the front of the vehicle via a crossbar structure having at least one mounting via which it is attachable to the unit and a crossbar supported from the mounting(s) and receivable adjacent a lower part of the vehicle for attachment thereto. Preferably, the crossbar is supported by the mounting(s) in a manner permitting rotation of the crossbar about a longitudinal axis thereof.

According to a sixth aspect of the present invention, there is provided a combination comprising:
a unit according to the fifth aspect;
said handle; and
said wheels.

Preferably, the wheels are configured to be coupled to the unit at selectably variable positions whereby the spacing between a rotary brush of the unit and the ground is adjustable when the unit is operable in the walk-behind manner or by pushing or pulling thereof over the ground. Preferably, the combination includes fittings configured to couple the wheels to the unit, the fittings being attachable to the wheels and/or the unit at selectably variable positions whereby said spacing is adjustable. Preferably, each fitting includes a mount, via which it is attachable to the unit, and a wheel support member, extending from the mount, to which the respective wheel is attachable at a plurality of selectable positions therealong whereby said spacing is adjustable. Preferably, the fittings are attachable to the unit in both a first orientation, in which the wheel support members extend generally upwardly from the mount, and a second orientation, in which the wheel support members extend generally downwardly from the mount, whereby said spacing is adjustable within two different ranges of spacing, one of which is ranges is higher than the other.

Preferably, the combination further comprises means for mounting the unit at the front of the vehicle. Preferably, said means comprises fittings.

In a preferred embodiment of the invention, the means for mounting the unit at the front of the vehicle comprises at least one tie engageable with the vehicle to secure the unit to the vehicle. Preferably, the or each tie is engageable with a bull bar structure and/or bumper of the vehicle. The or each tie may, for example, comprise a strap. Alternatively, the or each tie could comprise, for example, a chain, rope or cable.

In a preferred embodiment of the invention, the means for mounting the unit at the front of the vehicle comprises a crossbar structure having at least one mounting via which it is attachable to the unit and a crossbar supported from the mounting(s) and receivable adjacent a lower part of the vehicle for attachment thereto. Preferably, the crossbar is supported by the mounting(s) in a manner permitting rotation of the crossbar about a longitudinal axis thereof.

Preferably, the crossbar is configured to be, when attached to the unit via the mounting, attachable to the vehicle adjacent to said lower part via at least one said tie. Preferably, said lower part comprises a bumper of the vehicle.

According to a seventh aspect of the present invention, there is provided a brush harvesting apparatus, comprising:
a unit as defined above;
said handle arrangement; and
said wheels,
wherein said handle arrangement and said wheels are coupled to the unit, such that the unit is operable in said walk-behind manner or by pushing or pulling thereof over the ground.

According to an eighth aspect of the present invention, there is provided a brush harvesting apparatus, comprising:
a unit as defined above; and
said vehicle,
wherein the unit is mounted to the vehicle to be operable by driving of the vehicle.

According to a ninth aspect of the present invention, there is provided:
a brush harvester unit as defined above/according to the fifth aspect; and
fittings enabling the unit to be operated in said walk-behind manner or by pushing or pulling thereof over the ground, or to be mounted to the vehicle to be operable by driving of the vehicle.

Preferably, the fittings comprise a first set of fittings enabling the unit to be operated in said walk-behind manner or by pushing or pulling thereof over the ground and a second set of fittings enabling the unit to be mounted to the vehicle to be operable by driving of the vehicle.

### BRIEF DESCRIPTION OF THE DRAWINGS

The present invention will now be described, by way of non-limiting example only, with reference to the accompanying drawings, in which:

FIG. 1 is a schematic side elevation view showing features of a conventional brush harvester;

FIG. 2A is a rear three-quarter view of a brush harvester unit according to a preferred embodiment of the present invention;

FIG. 2B is a front three-quarter view the brush harvester unit;

FIG. 3 is a perspective view of the brush harvester unit, depicting a casing and safety guard of the unit in phantom to show a chassis, hopper, drive system and brush of the unit;

FIG. 4 is an exploded view of the unit minus the casing and safety guard;

FIG. 5 is a view of the unit minus the casing and safety guard, and fittings attachable to the unit to render it operable in a walk-behind manner;

FIG. 6 is a view showing a walk-behind brush harvester comprising the unit and the fittings of FIG. 5 attached thereto;

FIG. 7A is a side view of the walk-behind harvester in a parked condition, indicating adjustability of the level of a handle of the harvester;

FIG. 7B is a side view of the walk-behind harvester being operated;

FIG. 7C is a side view of showing tilting of the walk-behind harvester to adjust the spacing of a brush of the unit and the ground;

FIG. 8 shows details of a handle and stand assembly comprising fittings illustrated in FIG. 5;

FIG. 9A shows wheel brackets attached to the chassis of the unit in an inverted orientation, to permit both adjustment of the walk-behind harvester through an additional range of heights and attachment of a support member for vehicle-mounting of the unit;

FIG. 9B is a side view of the walk-behind harvester, in which the wheel brackets are in the inverted orientation;

FIG. 10 is a view of the unit and fittings via which the unit may be mounted to a vehicle for operation thereby;

FIG. 11 an assembly comprising the unit and fittings as shown in FIG. 10 attached thereto;

FIG. 12A shows a vehicular brush harvester comprising a vehicle, the unit mounted to the vehicle, and the fittings shown in FIG. 10 via which the unit is so mounted; and

FIG. 12B is a side view of the vehicular brush harvester, showing tilting of the unit to adjust the spacing between the brush and the ground.

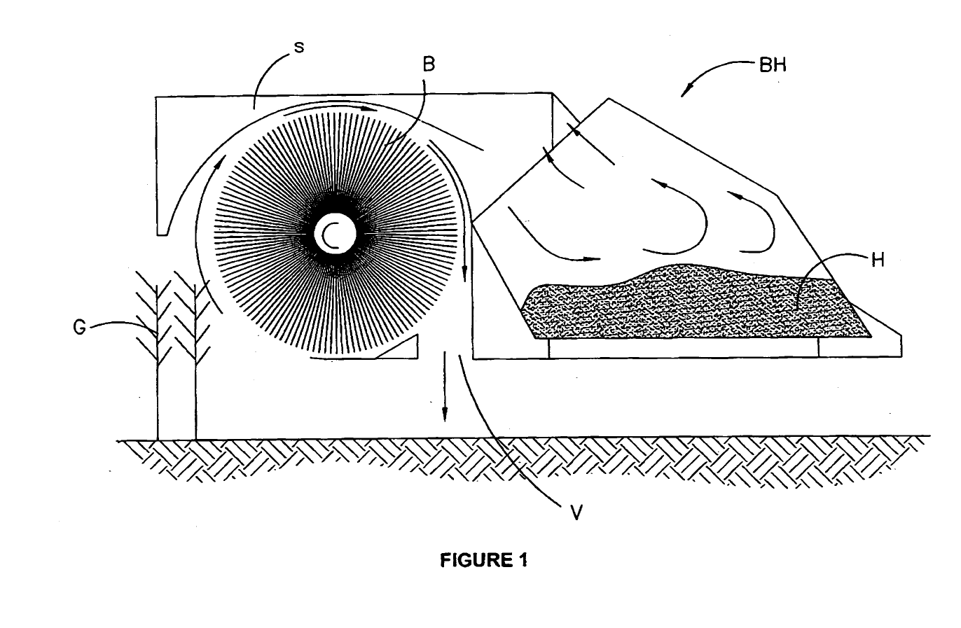

### DETAILED DESCRIPTION OF PREFERRED EMBODIMENT(S) OF THE INVENTION

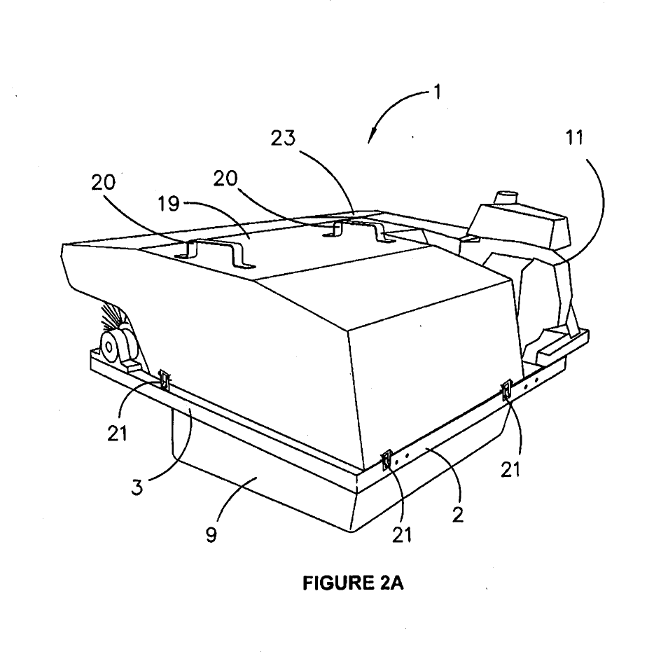

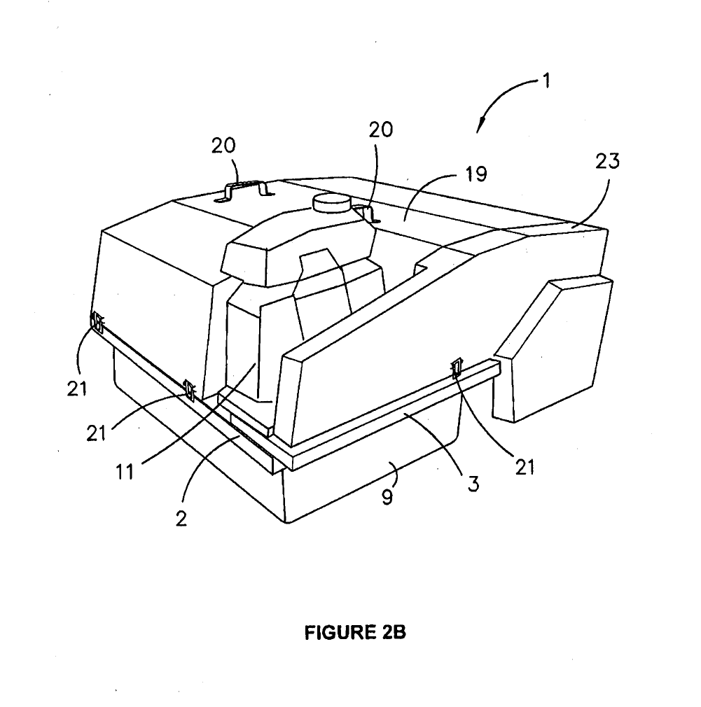

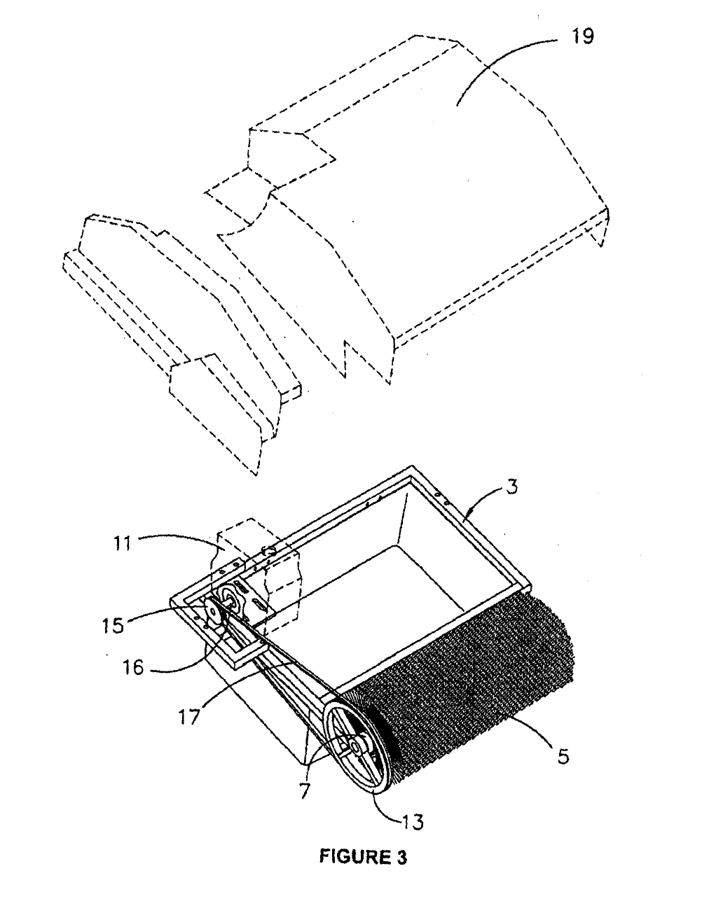

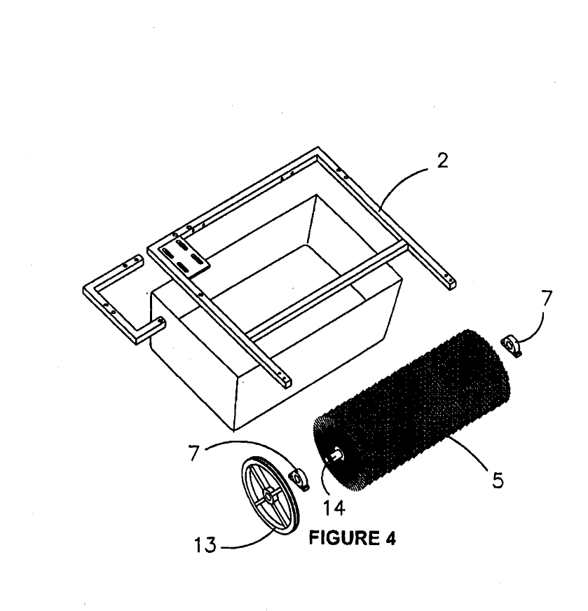

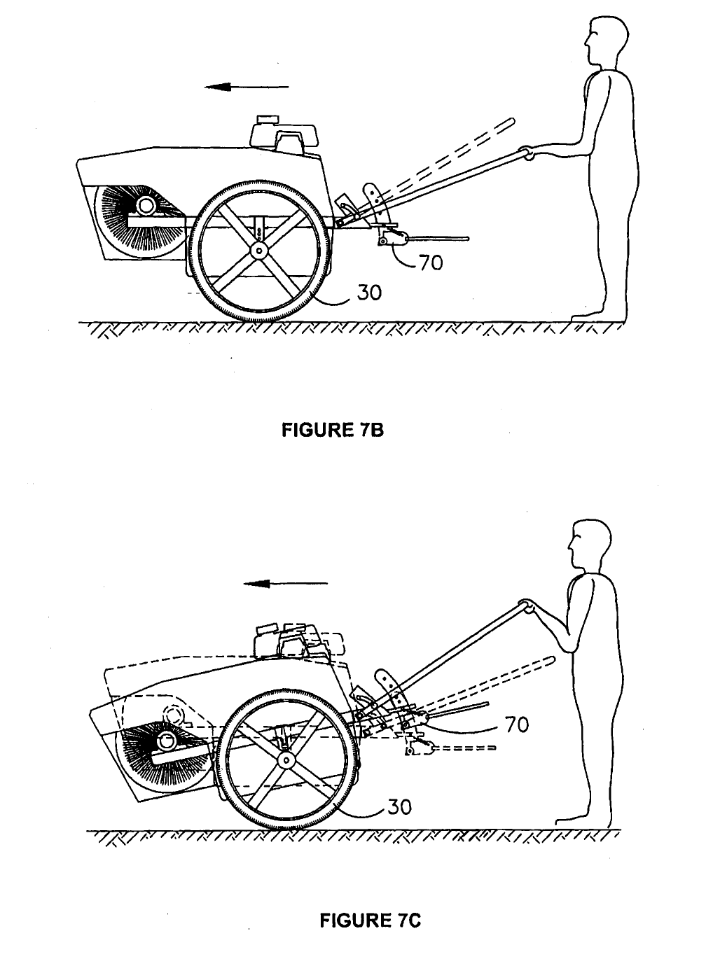

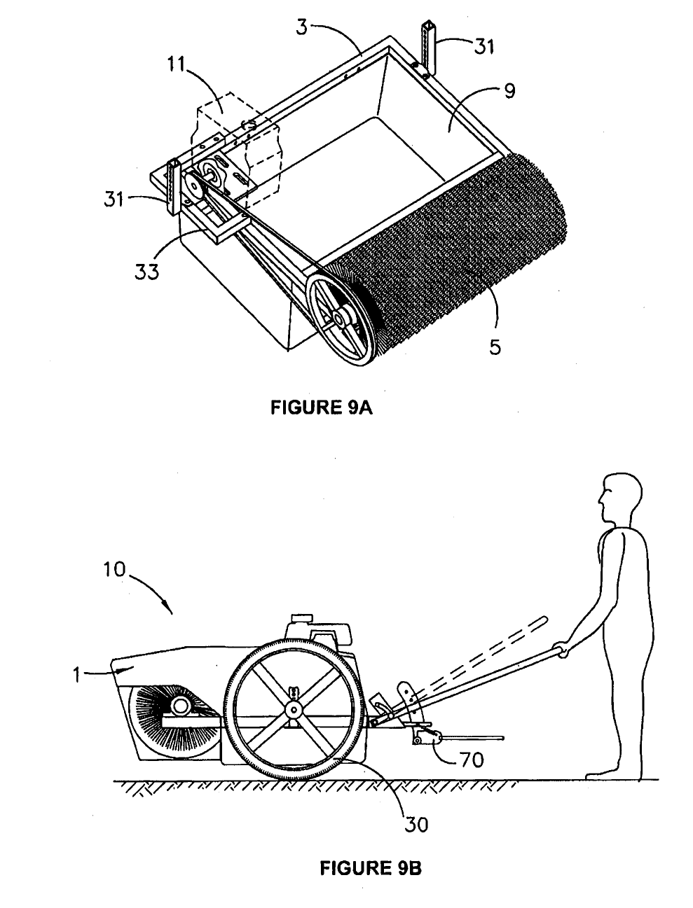

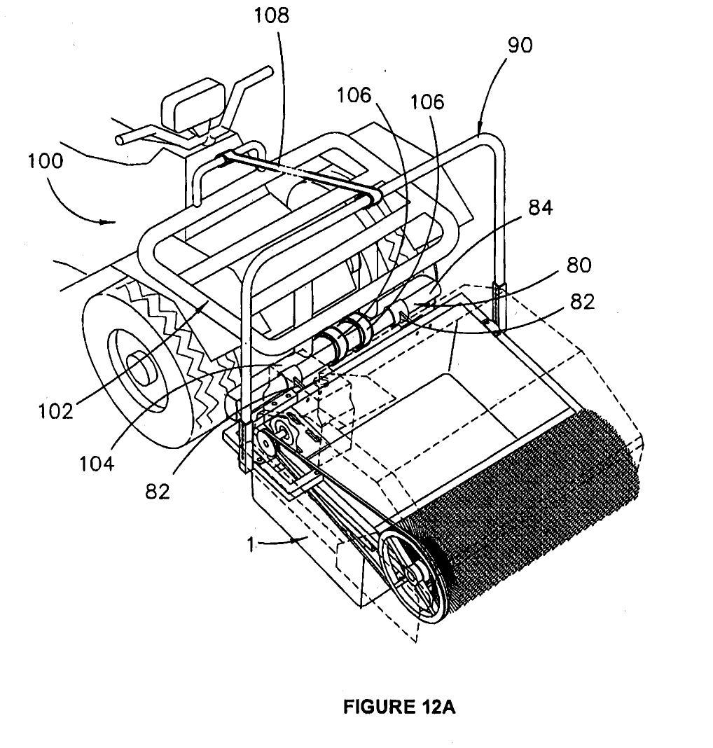

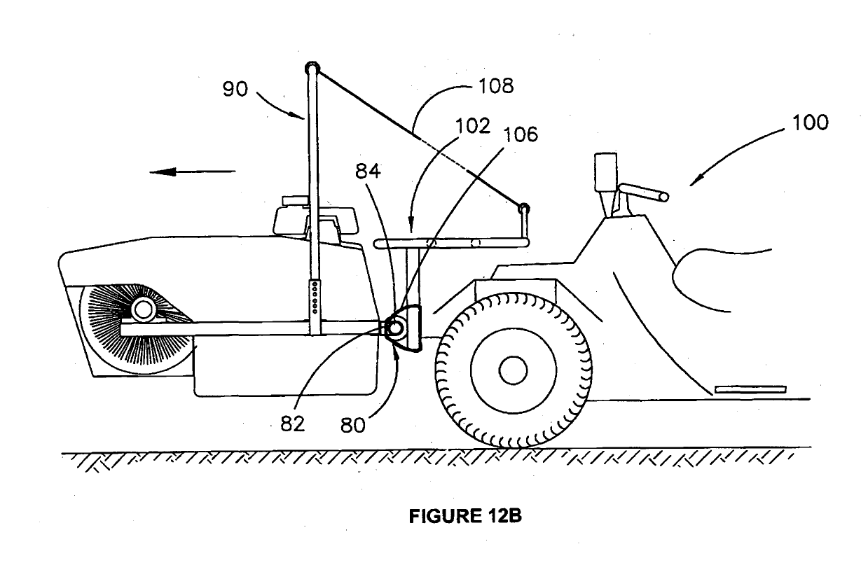

A brush harvesting unit 1 according to a preferred embodiment of the present invention is illustrated in FIGS. 2A, 2B and 3. The unit 1 has two modes of operation, namely a vehicle-mounted mode, as shown in FIGS. 12A and 12B, and a wheel-mounted mode, as shown in FIGS. 7A to 7C and 9B, which modes will be described in further detail later. The unit 1, when appropriately supported over the ground, is operable to collect seeds consistent with a conventional brush harvester as previously described.

The unit 1 includes a chassis 3 comprising a steel rectangular hollow section main frame 2, a conventional rotary brush 5 mounted, via bearings 7, at a front end of the chassis 3, a hopper 9, in the form of a canvas catch-bag or tray, supported by the chassis 3 and arranged behind the brush 7, and a four-stroke motor 11 (e.g. 50 cc) adjustably mounted to a base plate 12 provided at a rear corner position on the chassis 3, the base plate 12 triangulating the corner of the frame 2 and thus reinforcing it. The unit 1 further includes a driven pulley 13 mounted at an end of a shaft 14 on which the brush 5 is fixed, a drive pulley 15 mounted at the end of an output shaft 16 of the motor, and a belt 17 trained over the pulleys 13, 15 to transfer drive from the motor output shaft 16 to the brush shaft 14 and thus effect rotation of the brush 5. The motor 11 is bolted to the base plate 12 through slots 18 such that, when the bolts are slackened the position of the motor 11, and so the tension in the belt 17, can be adjusted.

The bristled section of the brush 5 preferably has a length (i.e. a dimension parallel to its rotational axis) which is less than 1.5 metres, whereby the unit 1 is particularly suited for being mounted to an all-terrain vehicle, as will be described in further detail later. The length of the bristled section in the present embodiment is about 0.75 m. The unit 1 preferably weighs less than 100 kg, whereby it can be particularly suited to being mounted to an all-terrain vehicle.

The unit further comprises a fibreglass-reinforced plastic cover or shroud 19 which covers the hopper 9 and a top portion of the brush 5 and which is removably mounted to the chassis 3 via quick-release fasteners 21 which, when released, permit removal of the shroud 19 from the chassis 3 and thus access to the brush 5 and hopper 9. The shroud 19 is provided with spaced apart handles 20 which facilitate its removal from the chassis 3. The unit 1 also includes a removable fibreglass-reinforced plastic safety guard 23 which covers the pulleys 13, 15 and belt 17.

In the wheel-mounted mode, the unit 1 is supported over the ground via coaxial ground-engaging wheels 30 and is fitted at its trailing end with a handle structure 60, whereby it can be pushed over the ground and thus operated in a walk-behind manner, somewhat consistent with a manually pushed lawnmower.

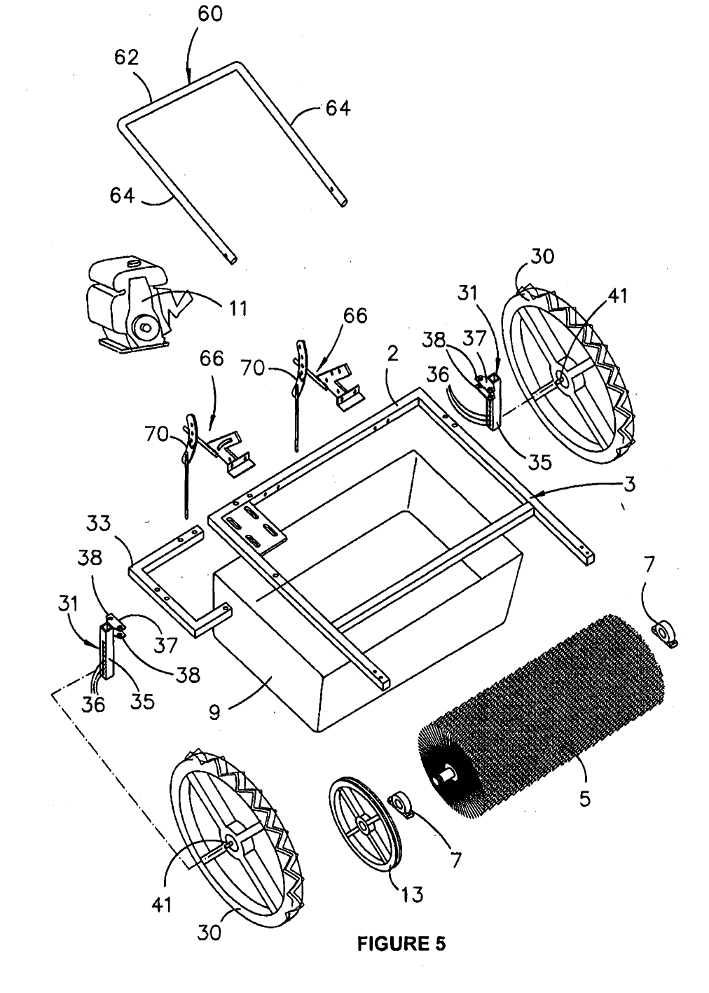

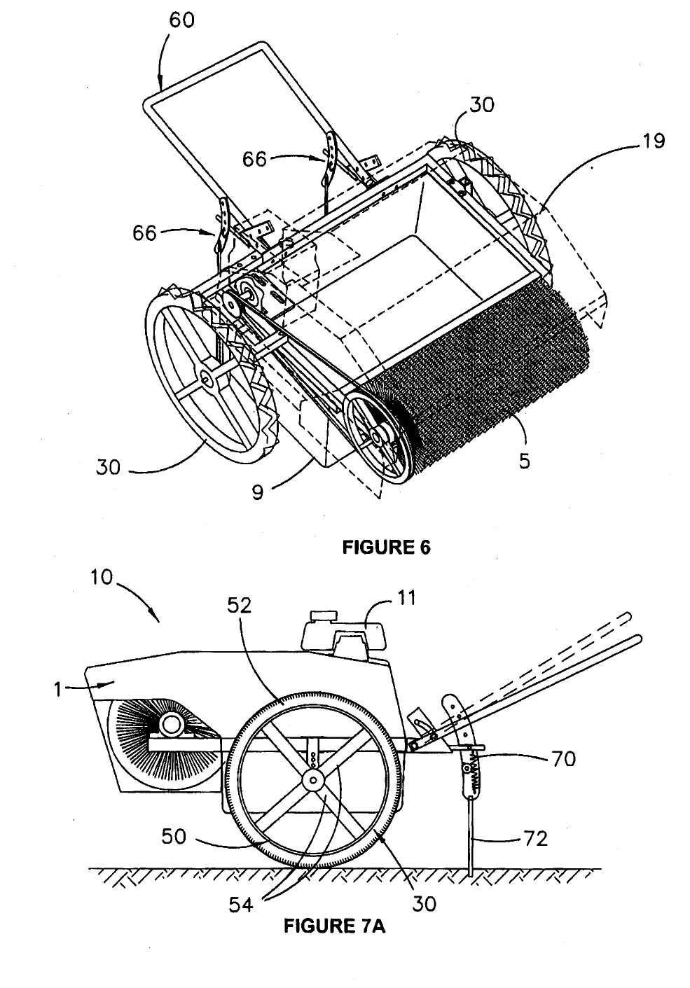

Each wheel 30 is rotatably mounted to a respective bracket 31 via which it is removably attached to the chassis 3. On the non-motor side of the unit 1, the bracket 31 attaches directly to the chassis main frame 2, whereas on the motor side of the unit, the bracket 31 attaches to an outrigger member 33 which forms part of the chassis 3 and is removably fixed, via bolts, to the frame 2 at that side, the outrigger member 33 serving to space the bracket 31 at that side sufficiently laterally outward of the motor 11. Each bracket 31 comprises an elongate portion or leg 35 and a mounting section 37 which comprises spaced apart flange members 38 fixed to the leg 35 adjacent an end thereof. The flange members 38 are spaced so as to receive closely therebetween the main frame 2 and outrigger member 33, as shown in FIGS. 5 and 6. Aligned pairs of holes are provided through the flange members 38, which align with a pair of holes provided through the main frame 2 and outrigger member 33, the aligned holes receiving mounting bolts therethrough. Each leg 35 is formed with holes 36 therethrough provided at spaced apart positions therealong for receipt of a shaft 41 to which the respective wheel 30 is rotatably attached. The shafts 41 are sufficiently long to extend through the holes 36 and are threaded for attachment of nuts thereto when they are so received, whereby each wheel 30 is removably attachable to the respective leg 35 at any of a plurality of positions therealong, so that the position of the axis of rotation of the wheels 30 with respect to the chassis 3, and thus the spacing of the brush 5 from the ground, is adjustable, according, for example, to the height of grass from which the unit is to be used to collect seeds. Advantageously, the brackets 31 can be mounted such that the legs 35 project either upwardly or downwardly, whereby the axis of rotation of the wheels 30 can be set at a number of positions both below and above the chassis 3, depending on the selected orientation of the brackets 31. The spacing of the brush 5 above the ground is, accordingly, adjustable between a minimum amount, which is shown in FIG. 7B, and a maximum amount, which is shown in FIG. 9B.

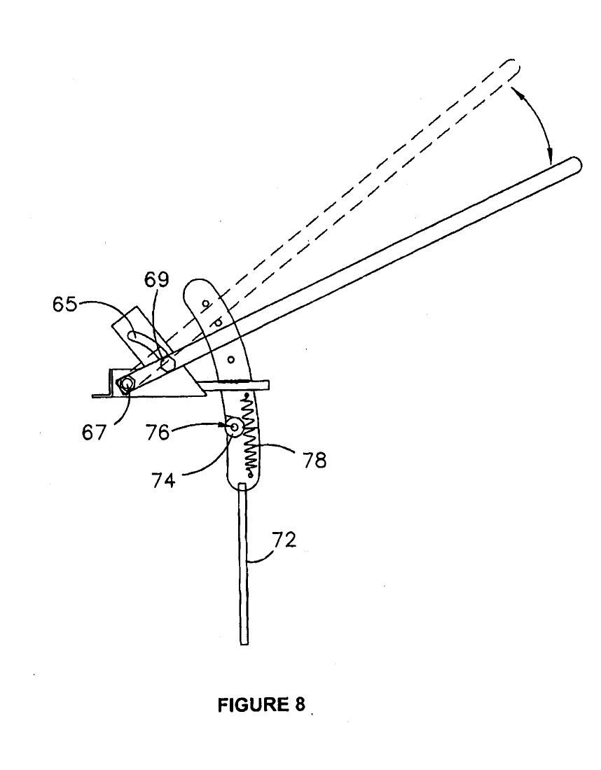

The handle structure 60 comprises a handle, in the form of a crossbar or handlebar 62, and a pair of parallel arms 64 which extend from opposite ends of the bar 62 and attach via bolts to brackets 66 which, in turn, are removably fixed, via bolts, to the rear of the chassis 3 when the unit is in the wheel-mounted mode. Referring to FIG. 8, each arm 64 is connected to the respective bracket 66 via two bolts: a proximal bolt 67, which pivotally mounts it to the bracket 66, and a distal bolt 69 received through an arcuate slot 65 in the bracket 66, which when slackened permits pivoting of the handle structure 60 substantially about an axis defined by bolt 67, and thus adjustment of the level of the bar 62, and when tightened frictionally engages the bracket 66 to lock the handle structure 60 rotationally. The arcuate slot 65 could be replaced with an arcuate arrangement of spaced apart bolt holes, in which case the handle would be adjustable in angular increments rather than along a continuum.

Also attached, e.g. via welds, to the brackets 66 are kick-stands 70, which may be conventional bicycle kick-stands and which are foot-operable to be placeable into an extended condition, shown in FIG. 7A, in which legs 72 thereof project downwardly to engage the ground and thus support the rear of the unit 1 such that the harvester 10 rests in an upright orientation on the ground without requiring any external support, and a retracted condition, shown in FIG. 7B, in which those legs are clear of the ground so as not to hinder walk-behind operation of the harvester 10. Each stand 70, consistent with a typical bike stand, includes a mounting 74, about which leg 72 pivots, a foot-operable lever 76 mounted to the leg 72 so as to be able to rock with respect thereto, and a spring 78 extending between the mounting 74 and lever 76. When the leg 72 is in its extended orientation, the lever 76 can be pushed by the operator's foot, against the spring bias, to assume an over-centre orientation which serves to lock the leg 72 in its extended orientation. Forces on the harvester 10 in a forward or rearward direction are then resisted by the engagement between the legs 72 and the ground, the latter possibly being penetrated to an extent by the former, as shown in FIG. 7A, so that the stands 70 additionally function as park brakes. Advantageously, the operator can use one of his or her feet to move each leg 72 from its extended position to its retracted position (and vice versa), and to operate the lever 76 to lock and unlock the leg 72 in the former position.

Referring in particular to FIG. 7A, the wheels 30 are, or resemble, typical off-road bicycle wheels, each wheel 30 including a rim 50 and tyre 52. The rims 50 preferably are formed of plastic and comprise bar-type spokes 54, instead of wire rod-type spokes, the relatively large spacing between adjacent ones of the former reducing the likelihood of grass, particularly long grass, becoming caught in the wheels 30. The wheel diameter (which in the present embodiment may be, for example, 20″ or 26″), tyre tread configuration and tyre thickness may vary according to the application in which the harvester is to be used, without departure from the invention.

With reference to FIG. 7B, a person operates the harvester 10, with the stands 70 in their retracted conditions, by grasping the handle 62 and pushing the harvester 10 in a forward direction, thus operating it in a walk-behind manner. Because the unit 1 is supported solely by coaxial wheels, the axis of rotation of which is suitably spaced behind the brush 5, the operator can adjust the height of the brush 5 as the harvester 10 travels over the ground, simply by raising the handle bar 62 (to lower the brush 5) or lowering the handle bar 62 (to raise the brush 5), according to, for example, variations in grass length from one location to the next.

In an alternative embodiment of the invention, the unit may be provided with an arrangement whereby it may instead be pulled over the ground, such as a handle or towbar structure extending forwardly from the unit 1, which can be pulled by a person or vehicle respectively.

With reference now to FIGS. 12A and 12B, the unit 1 in its vehicle-mounted mode of operation is mounted to an all-terrain vehicle (“ATV”) which, in the present embodiment, is a four-wheel motor bike or “quad-bike” 100, which may comprise a steering handlebar assembly as shown or instead comprise a steering wheel. In this mode, the unit 1 is fitted with different attachments, via which it is supported from the ATV 100. In particular, the unit 1 in the vehicle-mounted mode is not fitted with the assembly comprising brackets 66, handle attachment 60 and stands 70, and furthermore is not fitted with the wheels 30. Mounted to the rear of the chassis 3, instead of the brackets 66, is a lower support member 80, which comprises a pair of rearwardly projecting brackets 82 bolted to the chassis frame 2, via the same mounting holes as used for brackets 66, and a crossbar member 84 opposite ends of which are received through sleeves 83 formed at rear ends of the brackets 82 such that the crossbar member 84 is rotatably held by the brackets 82 and is mounted to the chassis 3 via those brackets 82. The crossbar 84 comprises a steel inner tube 85 and a soft sleeve 86 received over the portion of the tube 85 which extends between the sleeves 83 to enhance abutment between the crossbar 84 and the part of the ATV against which it is to be received, and to reduce the likelihood of the crossbar 84 damaging the ATV 100. The crossbar 84 is positioned adjacent the front bumper 104 provided on the carry rack or bull bar structure 102 of the ATV 100 and is attached thereto via ties 106, in the form of spaced apart belts or straps which wrap around the crossbar 84 and part of the carry rack or bull bar structure 102 (including bumper 104) and are closed to form loops by engagement of respective hook and loop portions, of a hook-and-loop fastener system, provided on opposite sides of the belts. The ties 106 are formed of suitably strong webbing, such as seatbelt webbing.

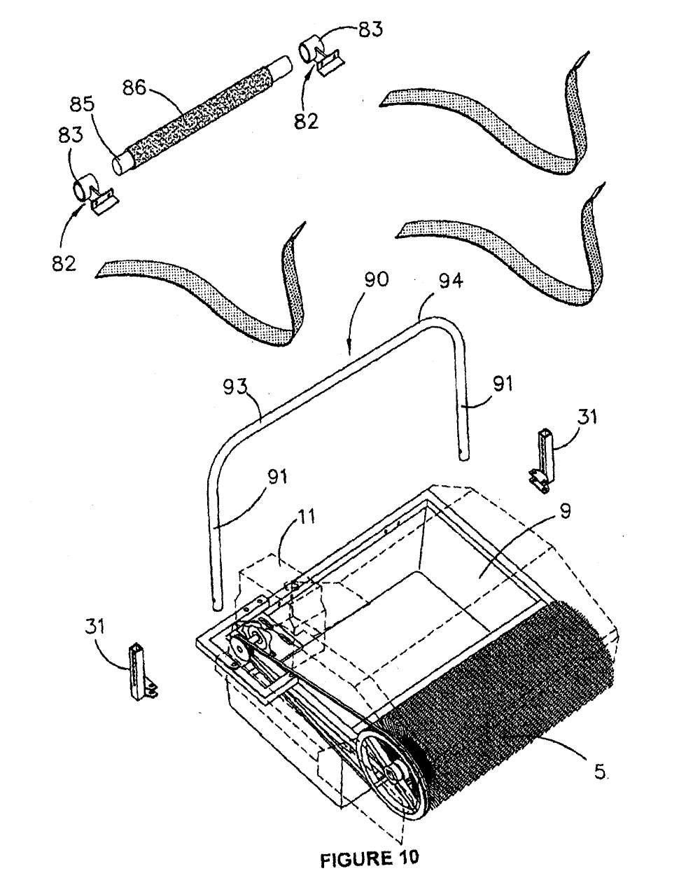

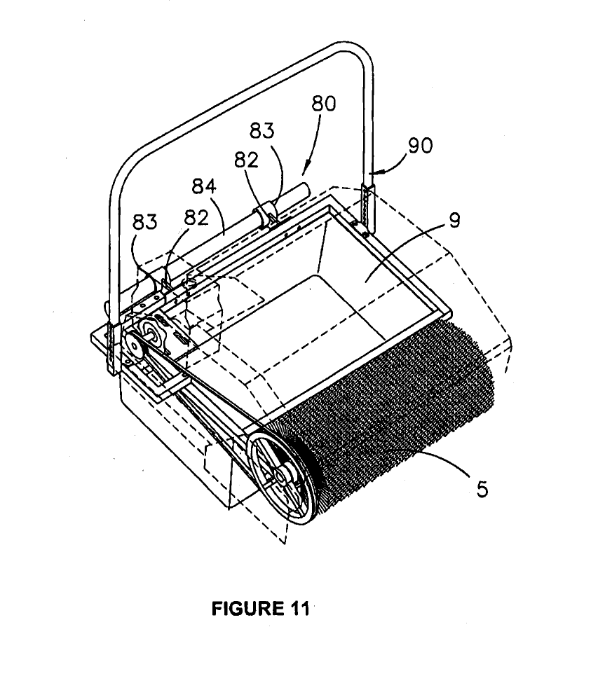

The unit 1 is additionally fitted with an upright frame member 90 which has an inverted u-shaped configuration and projects upwardly from the unit 1. The frame member 90 comprises an inner u-shaped member bent from tubular steel section, whereby the frame member 90 comprises downwardly projecting legs 91 and a cross member 93 extending between upper ends of the legs 91, and further comprises a soft sleeve or lagging 94 which surrounds the member 93, the lagging 94 and member 93 forming a crossbar. Referring to FIGS. 10 and 11, the wheel brackets 31 are mounted to the sides of the chassis 3, in the manner previously described, with the legs 35 thereof projecting upwardly for bolted receipt therein of respective lower ends of the legs 91, which comprise exposed lower ends of the u-shaped member. It will be noted that, to this end, the legs 35 are hollow and are open at distal ends thereof. A tie 108 is connected at a forward end thereof to the crossbar, the fixing between the two being enhanced by the lagging 94, and extends diagonally, i.e. rearwardly and downwardly, therefrom to a rear portion of the bull bar structure 102, the tie 108, in tension, and frame member 90 together applying a moment to the unit 1, about the crossbar 84, which counteracts the moment, about that crossbar, created by the weight of the unit 1, whereby the unit 1 is supported in a manner such that the mouth of the hopper 9 is generally parallel with the ground surface. The length of the tie 108 is adjustable such that the unit 1 can pivot, generally about the crossbar 84, whereby the spacing between the brush 5 and the ground surface can be altered to optimise operation, for example according to grass length.

In another embodiment, the unit may be mounted to another vehicle, such as, for example, a car or four-wheel drive vehicle (preferably a small such vehicle), and may be so mounted via or to a bull bar structure on that vehicle.

In another embodiment, the unit/harvester/harvesting apparatus may be configured to be pulled along/over the ground by a person in its wheel-mounted mode.

The preferred embodiments of the invention provide a number of advantages, including:
ease of harvester height adjustment via tilting/pivoting in either operational mode;
ease of identification, by the operator, of the species being harvested;
ease of identification of obstacles during operation;
manoeuvrability to avoid obstacles, such as trees and weeds, during operation;
light environmental footprint;
ease of disassembly and transportability;
elimination of requirement for a vehicle owing to wheel-mounted operability;
reduced risk of fire, particularly in long grass, owing to wheel-mounted operability; and
adaptability for optimal operation, owing to alternative operational modes.

Many modifications will be apparent to those skilled in the art without departing from the scope of the present invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

What claimed is:

1-50. (canceled)

51. A brush harvester including ground-engaging wheels so as to be operable in a walk-behind manner and/or by being pushed or pulled along the ground by a person walking on the ground.

52. A brush harvester according to claim 51, including a motorized harvesting brush.

53. A brush harvester according to claim 51, wherein the wheels are coaxial and the harvester includes a harvester unit, including a rotary brush, supported over the ground by the wheels, the unit being tiltable about the rotational axis of the wheels such that a spacing between the brush and the ground is adjustable.

54. A brush harvesting apparatus, comprising an all-terrain vehicle (ATV) and a brush harvester unit detachably mounted at a front end of the vehicle.

55. An apparatus according to claim 54, wherein the unit is attached to a carry rack or bull bar structure of the vehicle.

56. A brush harvester unit which is provided with ground-engaging wheels and configured to be supported over the ground by the wheels and to be operable, when so supported, in a walk-behind manner and/or by being pushed or pulled over the ground by a person walking on the ground the unit being mountable at a front of a vehicle to be operable by driving of the vehicle.

57. A brush harvester unit according to claim 56, being configured to be coupled to the wheels to be operable in the walk-behind manner and/or by being pushed or pulled over the ground, and such that the wheels can be decoupled therefrom for mounting of the unit at the front of the vehicle to be operable by driving of the vehicle, or such that the wheels are relocatable with respect thereto whereby the wheels are carried by the unit in a stowed condition when the unit is operable by driving of the vehicle.

58. A brush harvester unit according to claim 56, provided with a handle arrangement to which it is coupled to be operable in the walk-behind manner and/or by being pushed or pulled over the ground, and being configured such that the handle arrangement can be decoupled therefrom for mounting of the unit at the front of the vehicle, or such that the handle arrangement is relocatable with respect to the unit whereby the handle arrangement is carried by the unit in a stowed condition when the unit is mounted at the front of the vehicle.

59. A brush harvester unit according to claim 56, provided with a crossbar structure attached thereto, via which structure it is mounted to the front of the vehicle, the structure having at least one mounting via which it is attached to the unit and a crossbar supported from the mounting(s) and received adjacent a lower part of the vehicle and attached thereto, the crossbar being supported by the mounting(s) in a manner permitting rotation of the crossbar about a longitudinal axis thereof

60. A brush harvester unit according to claim 56, wherein the wheels are configured to be coupled to the unit at selectably variable positions whereby the spacing between a rotary brush of the unit and the ground is adjustable when the unit is operated in the walk-behind manner and/or by being pushed or pulled over the ground.

61. A brush harvester unit provided with means for mounting the unit to a front end of an all-terrain vehicle (ATV) such that the unit and ATV define a brush-harvesting apparatus.

62. A brush harvesting apparatus comprising a unit according to claim 61 and a driver-operable vehicle, wherein the unit is mounted to a front end of the vehicle via the mounting means.

63. An apparatus according to claim 62, wherein the vehicle is an ATV.

64. An apparatus according to claim 62, wherein the unit is attached, via the mounting means, to a carry rack or bar structure at the front end of the vehicle.
